(19) United States
(12) Patent Application Publication
(10) Pub. No.: US 2015/0348087 A1
(43) Pub. Date: Dec. 3, 2015

(54) FULLY PRIVATE MARKETING CAMPAIGN SYSTEM AND METHOD

(71) Applicant: Pitney Bowes Inc., Stamford, CT (US)

(72) Inventors: ROBERT A. CORDERY, Monroe, CT (US); FEMI OLUMOFIN, Trumbull, CT (US)

(73) Assignee: Pitney Bowes Inc., Stamford, CT (US)

(21) Appl. No.: 14/288,734

(22) Filed: May 28, 2014

(51) Int. Cl. G06Q 30/02

(52) U.S. Cl. CPC G06Q 30/0242; G06Q 2220/10

(57) ABSTRACT

A system and method that allows a business to obtain statistics to measure the progress of a marketing campaign while maintaining the privacy of consumer information, is provided. Using Private Information Retrieval (PIR) and other cryptographic privacy enhancing technologies, the consumer can request actions and receive responses from the business. The requests and responses are kept private from the business using PIR. The marketing strategy is represented as a graph with nodes representing the consumer states and links representing allowed transitions. The consumer request contains information about the consumer's state in the business's marketing strategy so that only allowed responses are made to the consumer. The business can monitor the overall execution of the marketing plan but cannot see the states or transitions of individual customers or their actions, searches or responses.

### FIELD OF THE INVENTION

The present invention relates to marketing campaign offers and personal information privacy, and in particular to a method and system for allowing merchants to obtain statistics to measure the progress of their marketing campaigns while maintaining the privacy of consumer information.

### BACKGROUND OF THE INVENTION

In many instances, a business conducts a marketing campaign to grow its business and promote customer loyalty. One such type of a marketing campaign (sometimes referred to as loyalty programs) provides a customer with different types of offers based on previous transactions made by the customer. A customer must register with the business by providing personal information, such as, for example, name, address, telephone number, age, and other demographic information. The customer can then transition between different states in the marketing campaign based on meeting some threshold requirements, based on the information they have provided and a history of their purchases, buying patterns, etc. This presents a conflict, however, between the business's goal of increasing its business and the customers' goals of maintaining their privacy. Many customers do not want to divulge personal information, and do not like having their purchase history tracked.

### SUMMARY OF THE INVENTION

The present invention alleviates the problems described above by providing a system and method that allows a business to obtain statistics to measure the progress of a marketing campaign while maintaining the privacy of consumer information. Using Private Information Retrieval (PIR) and other cryptographic privacy enhancing technologies, the consumer can request actions and receive responses from the business. The requests and responses are kept private from the business using PIR. The marketing strategy is represented as a graph with nodes representing the consumer states and links representing allowed transitions. The consumer request contains information about the consumer's state in the business's marketing strategy so that only allowed responses are made to the consumer.

In accordance with embodiments of the present invention, a business can execute a marketing plan with a set of customers and allow customers to search, receive and choose whether to accept allowed offers. Different offers and actions are available based on the customer's “state,” which includes the customer's personal information and past actions. The system is fully private in that the business can monitor the overall execution of the marketing plan but cannot see the states or transitions of individual customers or their actions, searches or responses. This could even include delivery of digital products without the business knowing who retrieved the product, or what transaction in their marketing plan allowed the consumer to retrieve the product. The system allows customers to receive only allowed messages and accept only allowed offers and transactions based on the consumer's state, thus enforcing the business's marketing policy.

The present invention provides the benefits of a customer relationship management system that helps a business take the best next action for each customer while maintaining privacy of the customer information and actions. The customer can receive better targeted offers and more relevant information by providing private information and preferences with the knowledge that it can influence the offers and other responses without having to reveal any private information and preferences to the business.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a portion of a fully private marketing campaign system according to embodiments of the present invention;

FIGS. 2 and 3 illustrate marketing campaigns represented as a directed graph with multiple nodes;

FIG. 4 is a flowchart illustrating operation of the system of FIG. 1 according to an embodiment of the present invention; and

FIGS. 5A and 5B are flowcharts illustrating an approach for privately obtaining statistics that businesses can use to measure the progress of marketing campaigns according to an embodiment of the present invention.

### DETAILED DESCRIPTION OF THE PRESENT INVENTION

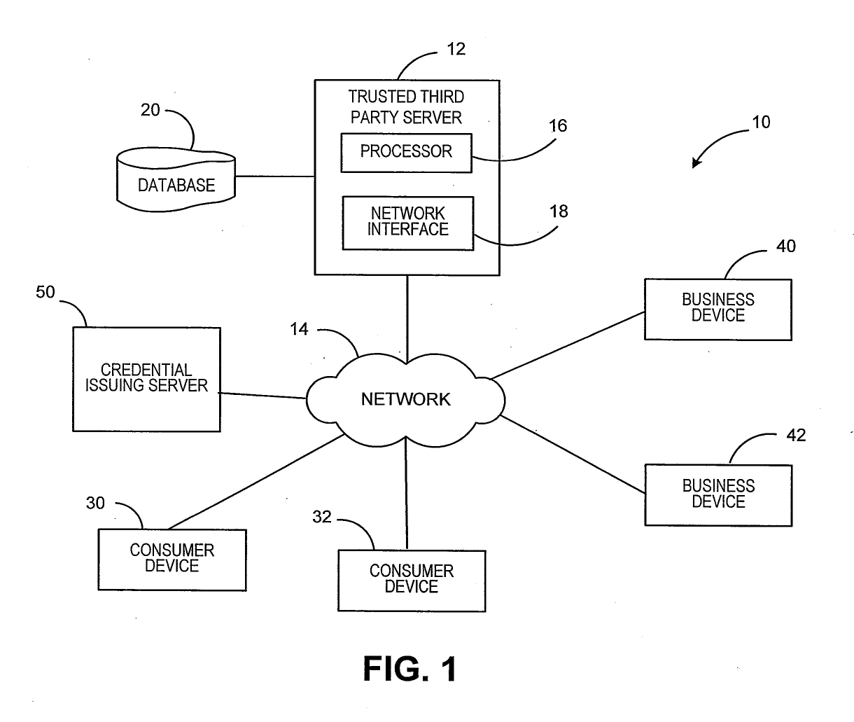

In describing the present invention, reference is made to the drawings, wherein there is seen in FIG. 1 in block diagram form a portion of a fully private marketing campaign system 10 that can be used to implement the method described herein according to embodiments of the present invention. System 10 includes a server 12 operated by a trusted third party, which may be, for example, a cloud service provider, that is coupled to a network 14, such as, for example the Internet. Server 12 may be a mainframe or the like that includes at least one processing device 16. Server 12 may be specially constructed for the required purposes, or it may comprise a general purpose computer selectively activated or reconfigured by a computer program (described further below) stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, which are executable by the processing device 16. One of ordinary skill in the art would be familiar with the general components of a computing system upon which the method of the present invention may be performed. A network interface 18 is provided to allow the server 12 to communicate with other devices via the network 14.

Such other devices can include one or more devices operated by a consumer/customer, e.g., consumer computing devices 30, 32. Consumer computing devices 30, 32 can include personal computers, tablets, smartphones or any other type of electronic device that has network capability and can allow a consumer to access other devices via the network 14. It should be understood that while two devices 30, 32 are illustrated in FIG. 1, there is no limit to the number of devices and/or users of such devices (consumers). System 10 also includes one or more business computing devices 40, 42, which can be similar to consumer computing devices described above. A business can be any type of service provider, merchant or third party acting on behalf of such entities that directly or indirectly sells products or services to consumers. It should be understood that while two businesses 40, 42 are illustrated in FIG. 1, there is no limit to the number of businesses.

System 10 also includes a database 20 that is in electronic communication with the server 12. Database 20 securely stores information that may be related to consumers, a business's marketing campaign, or other information as described elsewhere herein. System 10 also includes a credential issuing server 50 that is in electronic communication with the network 14. Server 50 operates to issue consumer credentials and refresh such credentials as described below. Server 50 can be similar to server 12 as described above.

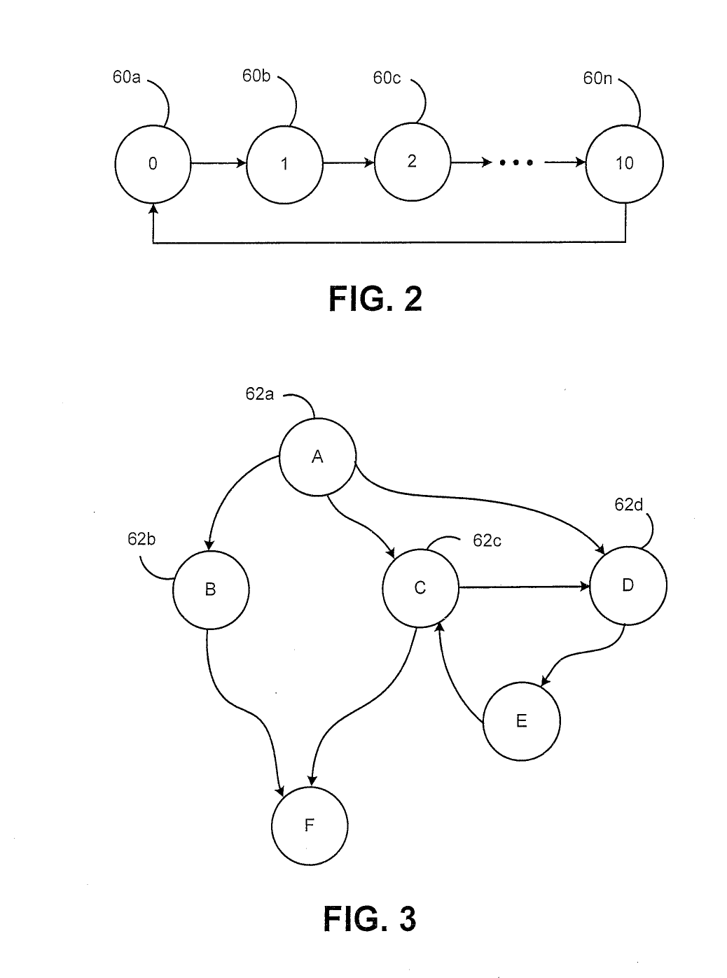

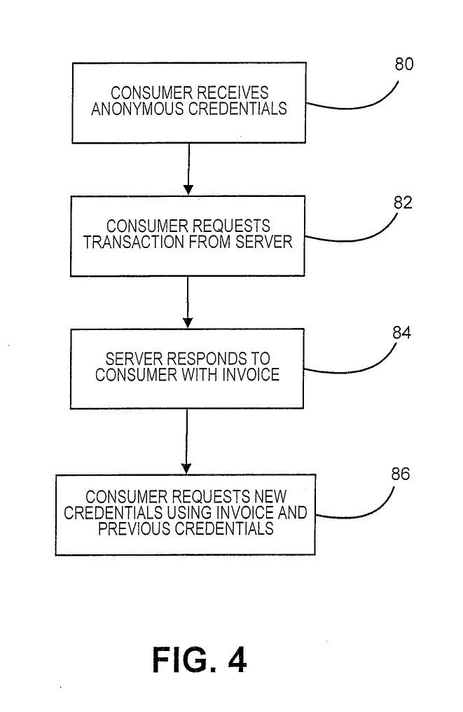

System 10 provides a way for a business to run a marketing campaign and for customers to prove they qualify for ads, offers and transactions from the marketing campaign and to take advantage of those offers, while maintaining the privacy of the consumers information and transactions but still ensuring for the business that the rules of the campaign are being followed in revealing offers and allowing consumers to take advantage of offers. As illustrated in FIG. 2, a simple marketing campaign can be represented as a directed graph with multiple nodes 60a, 60b, 60c, . . . , 60n. Each node represents a possible state of the customer in the marketing campaign. While FIG. 2 illustrates a campaign with 10 nodes, it should be understood that any number of nodes can be provided. The marketing campaign as illustrated in FIG. 2 illustrates a very simple campaign in which a consumer can only transition into a single state in the directed graph. Thus, for example, a consumer currently in state 1 (node 60b) can only transition into state 2(node 60c). In general, transitions between states are caused by some combination of marketing rules as determined by the business, consumer decisions and consumer information. In particular, a customer in state i must prove she qualifies for transition to state j (j>1). The criteria to prove may be according to some predetermined marketing campaign rules, e.g., the customer only qualifies for a bonus coupon after reaching state 10, or according to some consumer information, e.g., the customer must prove she is an adult with sufficient credit before being able to transition to a particular state. In some situations, a customer may be able to choose between two or more next states, provided such is allowed by the rules of the campaign. FIG. 3 illustrates a graph of a marketing campaign in which a consumer can transition from some states into more than one next state. The business provides the marketing campaign materials and rules to the server 12 which can be stored in database 20. The server 12 encodes the market campaign graph in such a way that each node has a price associated with it. For example, start state may have a price of 0, while all the states adjacent to the root will have a price of 1. The states that are adjacent to these may have the price of 2 and so on. The prices are in increasing order of some hierarchical ordering of the states in the graph; states at the same level in the hierarchy have the same prices. The state credit in the consumer's credential must be at least equivalent to the price of a state before it can retrieve the state; as well those states that are adjacent to the consumer's current state in the graph. Thus, for example, a customer currently in state A (node 62a) can transition into anyone of states B, C, or D (nodes 62b, 62c, or 62d, respectively) provided the criteria for such transition has been met. Again, transitions between states are caused by some combination of marketing rules, consumer decisions and consumer information. The system 10 allows a business to receive statistical reports about the performance of a marketing campaign. Such reports can include, for example, the number of people at each state, number and type of transactions, and statistics for each product. If the customer provides information such as age, gender, address information, or credit information, it can be protected and stored in a credential such that the business does not have access to such information, but such information can be used to ensure a customer qualifies to transition to a different state in the marketing campaign.

A consumer can leverage private information retrieval (PIR) techniques to traverse a market campaign graph. Generally, the consumer asks for the start state (e.g., state A in FIG. 3). This may require proving that the prospective consumer satisfies the criteria to enter the campaign. The retrieved node of the graph will provide information on the next states and the criteria to satisfy to be able to transition to the respective states (e.g., B, C, or D). An example criterion can be for the consumer to hold a valid reference code printed on the receipt of purchase of an item associated with state A. Note that possessing a receipt does not automatically imply the business will learn the personal information of the consumer. While the business will know that it issued a receipt to a particular customer or some anonymous customer, it may not know their personal details. Further, if the purchase completed is through electronic means, payment and receipt can be made anonymous and unlinkable to the personal information of the consumer. As well, if the purchased item is delivered digitally, then the consumer's personal information is not required in this process. E-cash and other cryptographic payment systems (e.g., bitcoin) can be used to make the payment anonymous. In some instances, it is even possible to deliver a physical item in a manner that does not require the consumer to provide name, address, or other personal information. For example, the consumer may request for the item to be delivered to a service mailbox with a given ID. Another example criterion could be that the consumer is required to be an adult before being able to transition to C or D.

The consumer can leverage zero-knowledge proof (ZKP) techniques to prove satisfaction of state criteria without leaking any additional information beyond the fact. Note that the consumer does not need to disclose their desired next state (B, C, or D) for the proof. A ZKP of knowledge is an interactive proof system between two parties, such as a consumer and a verifier (i.e., server 12). The consumer's goal is to convince the verifier that she satisfiers certain criteria without the verifier being able to learn any additional information beyond the fact. For example, a consumer with a credential that encodes her age can use ZKP to prove to a verifier that she is an adult, without disclosing her age. The present invention can leverage many of the available zero-knowledge proof techniques, such as Yao's millionaires protocol (comparison proofs), Schnorr protocol (proofs of knowledge), Brands protocol (proofs of knowledge of a discrete log representation of a number), Boudot protocol (range proofs), and so on. An example of ZKP of knowledge follows. Assuming the credential issuing server 50 issues a credential h=g₁^{x1}·g₂^{x2}· . . . ·gₙ^{xn}, Sig_{{server 50}}(h), which encodes the following information x₁, x₂, . . . , xₙ for a consumer, where g₁, g₂, . . . , gₙ, are generators of a group of prime order p, we let Zₚ={0, . . . , p−1} and Sig_{{server 50}} (.) be a signature generated using the secret signing key of server 50. Afterwards, the consumer can prove knowledge of x₁, x₂, . . . , xₙ to the seller, without disclosing their values to the seller. The consumer does this by computing a witness w=g^{w1}·g^{w2}· . . . g^{wn}, from n randomly chosen values wᵢ and sends w to the verifier. The verifier creates a challenge c and sends it to the consumer. The consumer responds by computing rᵢ=cxᵢ+wᵢ, for i=1, 2, . . . , n and sends these back to the verifier. The verifier can verify the proof with a simple check (is g₁^{r1}·g₂^{r2}· . . . ·gₙ^{rn} equal to w·h^{c}?). If so, the verifier is convinced that the consumer knows x₁, x₂, . . . , xₙ, without the verifier learning these values. Using general ZKP techniques, the consumer can prove compliance with the criteria for transition to the next state of the marketing campaign; however, server 12 will not learn any information about what is encoded in the credential.

Subsequently, the consumer leverages PIR to retrieve the next node from the server 12. The use of PIR prevents the server 12 holding the marketing campaign from learning this next node (the new state of the consumer, B, C, or D). Generally, the nodes of the campaign graph (e.g., FIG. 3) are accessed as if they are a contiguous block of data in the order A, B, C, D, E, F. In order for the consumer in state A to transition to state C, for example, the consumer device 30 encodes the index of node C (i.e., 2) into a PIR query using a known PIR query generation algorithm, as well as the device 30 generates one or more appropriate witnesses using ZKP techniques to prove qualification for an A-to-C transition. The device 30 sends the resulting query and witnesses to server 12. The server 12 creates a challenge and sends it back to the consumer device 30. The consumer device 30 computes a response to the challenge and forwards it to server 12. The server 12 checks the response for validity and proceeds with processing the PIR query it received previously if the response is valid or aborts the PIR query processing if the response is invalid. For valid responses, the server 12 encodes a PIR response using a PIR response generation algorithm, which takes as input the PIR query and the block of data for the campaign graph. The encoded response is sent to the consumer device 30, which can now use a PIR response decoding algorithm to obtain the information for node C. The above process can be repeated unless the consumer has transitioned to a terminal state of the market campaign graph, (e.g., state F in FIG. 3). The above method does not allow the server 12 (or any business) to learn any information about consumers beyond proving qualification, which is required to enable consumers to advance their status in a marketing campaign. Note that if the consumer interacts with the server holding the graph data through an anonymous communication network, such as Tor, then the server will not be able to learn even the identity of the consumer.

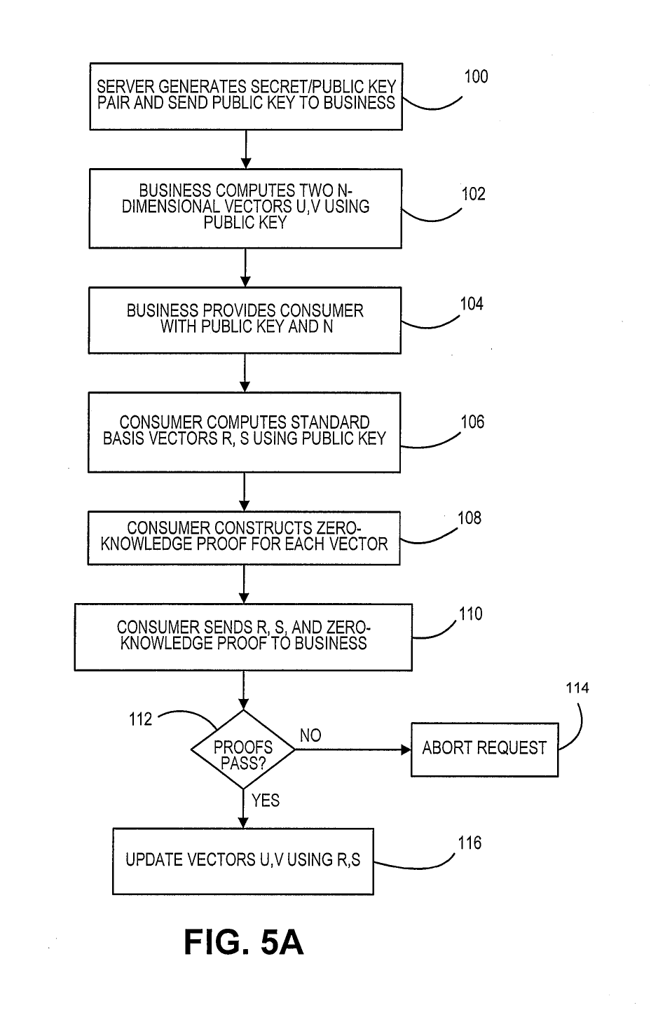

FIG. 4 is a flowchart illustrating operation of the system of FIG. 1 according to an embodiment of the present invention. In step 80, a new consumer requests an anonymous credential, using a consumer device 30, and receives it using a standard protocol by providing the request including some required private and public information to the credential issuing service 50. The credentials include a start state and possibly loyalty points. In step 82, the consumer requests a transaction, again using a consumer device 30, from server 12 and uses the received credentials in a zero knowledge proof (ZKP) to prove that the consumer is in a state where that transaction is authorized. In step 84, the server 12 responds to the consumer with an invoice that the consumer can use to prove the transaction took place. If the transaction is the purchase of information such as a song, ebook, computer program, or database, the product may be delivered through PIR with the invoice. In step 86, the consumer, using the invoice and previously used credential, requests and receives new credentials from credential issuing service 50. The new credentials may include additional loyalty points based on the transaction. The consumer can now use the new credentials to transition to the next state as applicable. As noted above, the above method does not allow the server 12 (or any business) to learn any information about customers beyond proving qualification using the credentials, which is required to enable customers to advance their status in a marketing campaign.

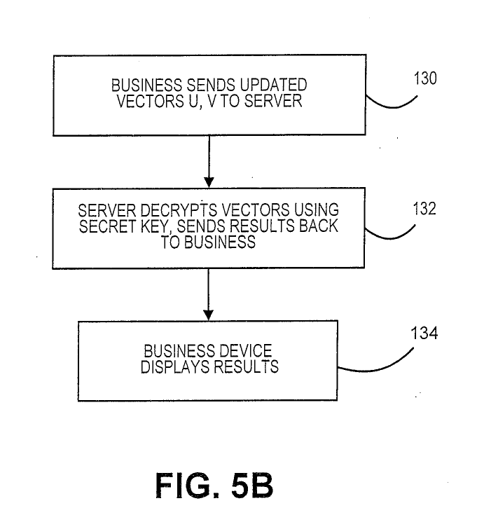

FIGS. 5A and 5B are flowcharts illustrating an approach for privately obtaining statistics that businesses can use to measure the progress of marketing campaigns according to an embodiment of the present invention. The techniques used are based on additively homomorphic encryption and zero knowledge proofs. Note that given the public key pk of an additively homomorphic cryptosystem, and the encryption of two messages m1 and m2 using a corresponding secret key sk, an encryption of their sum can be computed without the knowledge of the secret key sk (i.e., E(pk,m1).E(pk,m2)=E(pk,m1+m2)). Two vectors are used whose elements are encrypted counters to track the inflows and outflows of a campaign graph. The inflows of a node in the graph tracks the number of customers transitioning into or entering that state, while the outflows of a node tracks the number of customers leaving the state indicated by the node. The difference between these values gives the number of consumers currently in that state. The statistics generation process can be described in three stages: setup, tracking, and reporting.

In the setup stage, at the beginning of a marketing campaign, in step 100, the server 12 generates a secret key sk and a corresponding public key pk, and sends the public key pk to a business device 40, 42 associated with the business running the campaign while retaining the private key sk. On receipt of the public key pk, in step 102 the business, using the business device 40, 42, computes the encryption of two n-dimensional vectors U and V whose elements are encrypted counters to track the inflows and outflows of a campaign graph, where n is the number of nodes or states in the campaign graph, U={u1, un} and V={v1, vn}. This is performed by initializing each of the vectors' elements to an encryption of zero (i.e., E(U)={E(pk,u1), . . . , E(pk,un)} and E(V)={E(pk,v1), E(pk,vn)}, when ui=0 and vi=0 for 0≦i≦n. In step 104, the business, using the business device 40, 42, provides a device associated with the consumer, e.g., consumer device 30, 32, with the public key pk and n when the consumer enrolls for the campaign.

The tracking stage comprises the following. Recall that a consumer advances to the next state by proving qualification for that transition via zero knowledge proofs and by retrieving the corresponding information for that state through the PIR query. In step 106, the consumer device 30, 32 encrypts, using the received public key pk, two vectors R and S as follows: R={r1, rn} is a an n-dimensional standard basis vector (i.e., a vector with a 1 at the consumer's current node position and zero everywhere else). Similarly, S={s1, . . . , sn} is a standard basis vector with a 1 at the next node position the consumer intends to advance to and zero everywhere else. In other words, the customer computes encrypted vectors E(R)=(E(pk,r1), . . . , E(pk,rn)) and E(S)=(E(pk,s1), . . . , E(pk,sn)). The most recent node retrieved by the consumer using the PIR query provides information about the consumer's current state as well as pointers to a single or multiple different nodes that the consumer can advance to during the consumer's next transition of state. Note that the consumer can only advance to any one adjacent state out of the available adjacent next states, but the consumer has to choose only one of those and prove she qualifies for that transition. In step 108, for each encrypted vector, the consumer device 30, 32 constructs two zero knowledge proofs using known ZKP techniques to show that each element of the encrypted vector is either an encryption of counter value zero or one and that the sum of the encrypted vector elements is an encryption of counter value one. In step 110, the consumer device 30, 32 sends R, S, and the zero knowledge proofs to the business device 40, 42. Note that none of these leak information about the consumer's current and next states to the business.

On receipt of the information in step 110, in step 112 the business device 40, 42 checks the zero knowledge proofs. If any of the proofs do not pass, then in step 114 the request is aborted. If in step 112 all the proofs pass, then in step 116 the business device 40, 42 processes updates E(U) E(U+R), and E(V) E(V+S) from the two vectors R, S received in step 110. The business device 40, 42 is able to perform the computation because of the homomorphic property of the cryptosystem. The above achieves the goal of incrementing the counters tracking outflows from the consumer's current state and the counters tracking the inflows to the consumer's next state.

With consumers advancing through the campaign graph, a business can periodically obtain a report of the number of consumers in each of the nodes/states, and the inflows and outflows of each node (the reporting stage) as illustrated in FIG. 5B. In step 130, at the beginning of a reporting cycle a business device 40, 42 sends the two encrypted vectors E(U) and E(V) (from step 116 of FIG. 5A) to the server 12. In step 132, the server 12 decrypts the encrypted counters for the two vectors and sends the result back to the business device 40, 42. The inflow and outflow vectors show how many consumers have advanced from and advanced to the nodes corresponding to the vector positions. The difference between the respective values for a node is the number of consumers currently in that state. In step 134, the business device 40, 42 displays the decrypted results. Thus, a business can determine the progress of a marketing campaign by learning the number of consumers currently in each state, and the number of consumers that have transitioned to and from each state during the reporting period without obtaining any information about the consumers. Note that an ad-hoc report request from a business (outside of a reporting cycle) can leak information about consumer transitions. Hence, if the server 12 finds that the counters have not changed much since the last reporting cycle, it may deny providing the results to the business to protect consumers' privacy.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for a business to determine consumers' movement through a marketing campaign having a plurality of different states that maintains privacy of consumer information, each state having predetermined criteria that a consumer must meet to transition into that state, the method comprising:
computing, by a processing device, two n-dimensional vectors U and V, where n is the number of states in the marketing campaign, and the vector U is a counter to track inflow of consumers into each state of the marketing campaign and the vector V is a counter to track outflow of consumers from each state in the marketing campaign;
encrypting, by the processing device, the two n-dimensional vectors using a public key;
sending, by the processing device, the public key n to a consumer device associated with a consumer in a current state of the marketing campaign;
receiving, by the processing device, a first n-dimensional standard basis vector R encrypted using the public key having a value of one at the consumer's current state and zero at all other states, a second n-dimensional standard basis vector S encrypted using the public key having a value of one at a next state that the consumer intends to advance to and zero at all other states, and at least one zero-knowledge proof from the consumer device;
determining, by the processing device, that the at least one zero-knowledge proofs pass;
updating, by the processing device, the vectors U and V using the vectors R and S;
sending, by the processing device, the updated vectors U and V to a server for decryption using a private key that corresponds to the public key;
receiving, by the processing device, the decrypted vectors U and V from the server; and
displaying, by the processing device, the decrypted vectors U and V.

2. The method of claim 1, wherein a consumer can transition only into a single state from each state of the marketing campaign.

3. The method of claim 1, wherein a consumer can transition into one of a plurality of states from at least one state of the marketing campaign.
